(19) United States
(12) Patent Application Publication
(10) Pub. No.: US 2006/0259446 A1
(43) Pub. Date: Nov. 16, 2006

(54) METHOD OF SECURELY PROCESSING STAMP-DUTY STAMPS

(75) Inventor: Dennis T. GILHAM, Essex (GB)

Correspondence Address: SUGHRUE MION, PLLC, 2100 PENNSYLVANIA AVENUE, N.W., SUITE 800, WASHINGTON, DC, 20037, US

(73) Assignee: NEOPOST Technologies, Bagneux (FR)

(21) Appl. No.: 11/420,882

(22) Filed: May 30, 2006

(30) Foreign Application Priority Data
May 30, 2005 (FR) 0505431

(51) Int. Cl. G06F 17/00

(52) U.S. Cl. 705/408

(57) ABSTRACT

A method of securely processing stamp-duty stamps, in which method each of the stamp-duty stamps purchased is registered by a purchaser of said stamp-duty stamp with an authentication service before said stamp is affixed to the document that is to be validated by said stamp.

### TECHNICAL FIELD

The present invention relates to a method of securely processing stamps for non-postal use, such as stamp-duty stamps, in a non-secure environment.

### STATE OF THE ART

The use of stamps for uses other than for paying for postage is well known. Stamps are found in particular in the tax field for paying fines or various duties to the government authorities. Stamps are also found that are to be affixed to various types of official documents in order to confirm that such documents are valid, or indeed to certain deeds drawn up by legal officials such as notaries or bailiffs. Stamps having monetary value also exist in the insurance field or in the bank-loan field. In such non-secure environments, i.e. when such stamps are not conveyed through a network that is fully controlled, such as a postal network, no guarantee can be given as to whether the stamps are originals or mere copies.

The use of a special ink for printing them or of elaborate graphics can procure a certain amount of security for the issuer by making such stamps more difficult to copy, but under no circumstances constitutes sufficient protection against organized criminals who find it lucrative to participate in creating and distributing counterfeit stamps.

Patent U.S. Pat. No. 4,757,187 proposes a method of authenticating stamp-duty stamps that is based on using a terminal which is disposed on the premises of the stamp-issuing authority and to which the user must make a connection in order to receive authorization to print the stamps that the user needs on local printer means with which the user is equipped. That obligation for users to have their own printer means constitutes a serious drawback for that method which also requires a major change in the purchasing behavior of users who generally purchase any stamp-duty stamps they require from an intermediary and not directly from the tax authority.

### DISCLOSURE OF THE INVENTION

An object of the present invention is to mitigate those drawbacks by proposing a method of securely processing stamp-duty stamps that avoids any loss of revenue for the issuer while also minimizing the extent to which users have to change their habits.

These objects are achieved by a method of securely processing stamp-duty stamps printed by secure print means connected to a remote computer server, in which method a purchaser of a stamp-duty stamp communicates to an authentication service an encoded unique authentication number borne by said stamp-duty stamp, and at least one item of identity data concerning the purchaser in order to guarantee the validity of the document to which said stamp is affixed.

Thus, each printed stamp can be associated with one, determined purchaser only.

Preferably, the item of identity data comprises at least the identity and the telephone and address details of the purchaser, and said communication takes place over the Internet to which said purchaser makes a connection via any computer. The identity data may further consist in the document to which the stamp-duty stamp is affixed.

Advantageously, the encoded unique authentication number is decrypted by scanner and processor means which can thus verify the authenticity of the stamp-duty stamp.

The invention also provides a system for securely processing stamp-duty stamps, said system comprising:
secure print means for printing stamp-duty stamps, each of which bears an encoded unique authentication number;
a remote computer server connected to said secure print means for periodically establishing a statement of the printing operations performed, and in particular of the itemized amounts of stamp duty of the printed stamps; and
an authentication service which is accessible via the Internet from any computer and to which a purchaser of said stamp-duty stamps makes a connection for communicating said encoded authentication number and for registering at least one item of identity data concerning said purchaser.

Advantageously, said authentication service is also accessible via the Internet from any computer of any interested third party by means of the registration of identity data relating to the documents to which said stamp-duty stamps are affixed so as to guarantee validity thereof.

In order to make it possible to verify the authenticity of said stamp-duty stamps, the system of the invention may further comprise scanner and processor means.

### BRIEF DESCRIPTION OF THE DRAWINGS

Other characteristics and advantages of the present invention appear more clearly from the following description given by way of non-limiting indication, and with reference to the accompanying drawings, in which:

FIG. 1 shows an example of computer network architecture making it possible to implement the method of the invention for securely processing stamp-duty stamps; and

FIG. 2 is a flow chart showing the various steps of the method of the invention.

### IMPLEMENTATION(S) OF THE INVENTION

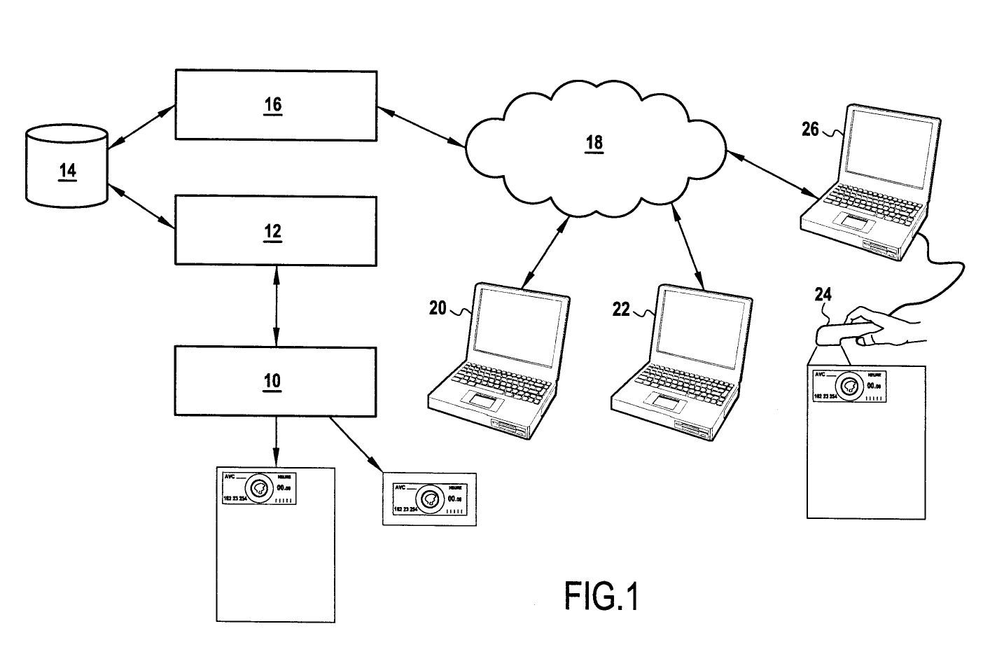

FIG. 1 diagrammatically shows a computer network architecture that can exist between an authority responsible for issuing stamp-duty stamps, an intermediary entrusted with distributing the stamps, and a user/recipient of the stamps, it being possible for the method of the invention to be implemented in this computer network architecture.

In this architecture, instead of the stamp-duty stamps being printed directly by the authority, they are printed via intermediaries who are selected and approved by said authority and who, for that purpose, are equipped with secure printer means 10. The intermediaries can be semi-public or private bodies having accounts with the authority or with an authorized agent thereof, operation of said accounts being governed by a contract between the intermediary and the authority or the agent thereof.

The printer machine is a machine similar to a franking machine or postage meter and makes it possible to print stamp-duty stamps on labels or optionally directly on documents. It thus conventionally comprises print means and accounting means for keeping accounts of the stamp-duty values corresponding to all of the stamp-duty stamps printed. It also comprises encryption means for printing a unique encoded identity number on the stamp, in addition to the associated duty value, the identity number being formulated on the basis of said duty value, of the serial number of the machine, and of any other relevant information such as the name of the holder of the machine, the number of the holder's contract, etc. Similarly, in known manner, the labels can have security markings based on fluorescent ink or on micro-prints.

This machine 10 is connected remotely to a first computer server 12 disposed on a site of the authority or of its agent and including at least one database 14. The server receives periodically (at least once per day) a report of the printing operations performed by the machine (but a report after each printing operation is also possible), in particular the itemized amounts of the stamp duty printed, and the server debits the account of the holder of the machine accordingly. It can also update the printer machine, e.g. by sending new duty values or new types of stamp-duty stamps.

The database has an access shared with a second computer server 16 which is disposed on the site of an authentication service that can optionally be independent from the authority, and which hosts a Web Site to which it is possible to make a connection via the Internet 18, preferably from any computer terminal, e.g. a personal computer (PC) 20 of the user/purchaser of the stamp-duty stamp or a PC 22 of any interested third party such as a bank, an insurance company, a notary's practice, etc. to whom the stamp has been given in payment of a duty relating to a product or to a service.

Connection to the authentication service can be established from anywhere (on the site where the printing takes place or elsewhere) and makes it possible for all of these people to register or to check on-line the printed stamp-duty stamps, such registration consisting in associating the information readable from the stamp, in particular the type of stamp, the value of the stamp duty, and the unique encoded authentication number, with personal information relating to said people or to the document to which the stamp in question is to be affixed so as to ensure that said stamp is valid, and such checking consisting in verifying the input information. When the document is printed at the same time as the stamp-duty stamp, it is also possible for the registration to include sending the document or an image of it to the authentication service.

The authority can also check the validity of and authenticate the stamp-duty stamps that are delivered to it by using scanner means 24 connected to computer processor means, e.g. a PC 26, for reading and decrypting the unique encoded authentication number. The authority can also make a connection, via the Internet 18, to the second computer server 16 hosting the Web Site of the authentication service. In an advantageous implementation, said scanner and processor means can be incorporated into a single module such as a personal digital assistant (not shown) incorporating a digital camera and means for decrypting the unique number.

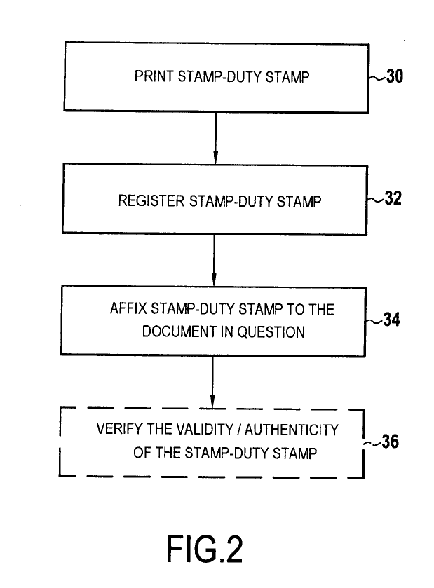

The method implemented in the above-mentioned network architecture is explained below with reference to the flow chart of FIG. 2. It comprises several steps. The first step is the printing step 30 consisting in printing the stamp-duty stamps and it is performed by the approved intermediaries. This printing, which comprises printing the stamp with the value of the duty and printing the encoded unique authentication number, is preferably performed stamp-by-stamp at the request of each purchaser, the intermediary then being debited merely at the end of the day for the amount of the duties corresponding to the stamps actually sold, but said printing can also be performed in one operation, e.g. at the beginning of the day, the intermediary then printing stamp-duty stamps for various amounts of duty in provision for its sales of the day (but the intermediary can then be debited for an amount of duty that is higher than its real sales in the event that some stamps remain unsold).

The second step is the registration step 32 consisting in the user/purchaser registering with the authentication service the stamp(s) that the user/purchaser has just purchased. This registration is performed by means of the user's/purchaser's computer or by means of a third party's computer via which the user/purchaser makes a connection to the Web Site of said service so as to communicate to said service various items of identity information concerning the user/purchaser, e.g. identity, postal address, telephone number(s), or other details, e.g. electronic items of information and concerning the stamp itself and the amount of the duty to be paid or the type of document to which it is to be affixed. Naturally, all of these items of information are associated with the encoded unique authentication number that is printed on each stamp purchased from the approved intermediary and that is also communicated to the Web Site. By means of the registration, and by means of the uniqueness of the encoded number, the user avoids any subsequent fraudulent use of a copy of the registered stamp. A second registration of the same stamp or of a copy is automatically detected or indeed refused by the authentication service.

The third step 34 consists in affixing the stamp-duty stamp on the document that is to receive it, and in giving the stamped document to the recipient in question who, if he or she so desires, can verify the validity and/or the authenticity of said stamp in a fourth step 36. If the recipient is a third party other than the authority, said third party can access the authentication service and, by communicating to it the encoded unique authentication code printed on each received stamp, check the data supplied by the intermediary and by the user and thus ensure that no attempt has been made to register said number twice, or indeed that the registered data does indeed correspond to the data of the user giving the document to said third party. Said third party can also communicate, in particular for use by the authority, information concerning said third party or identity data relating to the document. If said recipient is the authority itself, the authority can, in addition to the above-mentioned information and data with which it might become acquainted, verify the very authenticity of the stamp-duty stamp by decrypting it. In which case, it should be noted that the terminal of the authority can advantageously have software means which, on the basis of the input “fingerprint” of the stamp-duty stamp, and via a browser installed on said terminal, establish a direct connection, through the Internet, to which said terminal is connected, to a Uniform Resource Locator (URL) of a dynamic page of the Web Site of the authentication service, which page becomes filled in with all of the items of information associated with the encoded unique authentication number input previously by the intermediary and by the user, and optionally by the interested third party.

What is claimed is:

1. A method of securely processing stamp-duty stamps printed by secure print means connected to a remote computer server, in which method a purchaser of a stamp-duty stamp communicates to an authentication service an encoded unique authentication number borne by said stamp-duty stamp, and at least one item of identity data concerning the purchaser in order to guarantee the validity of the document to which said stamp is affixed.

2. A method according to claim 1, wherein said item of identity data comprises at least the identity and the telephone and address details of the purchaser.

3. A method according to claim 2, wherein said identity data further comprises the document to which the stamp-duty stamp is affixed.

4. A method according to claim 1, wherein said communication takes place over the Internet to which said purchaser makes a connection via any computer.

5. A method according to claim 1, wherein said encoded unique authentication number is decrypted by scanner and processor means which can thus verify the authenticity of the stamp-duty stamp.

6. A system for securely processing stamp-duty stamps, said system comprising:
secure print means for printing stamp-duty stamps, each of which bears an encoded unique authentication number;
a remote computer server connected to said secure print means for periodically establishing a statement of the printing operations performed, and in particular of the itemized amounts of stamp duty of the printed stamps; and
an authentication service which is accessible via the Internet from any computer and to which a purchaser of said stamp-duty stamps makes a connection for communicating said encoded authentication number and for registering at least one item of identity data concerning said purchaser.

7. A system according to claim 6, wherein said authentication service is also accessible via the Internet from any computer of any interested third party by means of the registration of identity data relating to the documents to which said stamp-duty stamps are affixed so as to guarantee validity thereof.

8. A system according to claim 6, further comprising scanner and processor means making it possible to verify the authenticity of said stamp-duty stamps.
